(19) United States
(12) Patent Application Publication
(10) Pub. No.: US 2025/0391981 A1
(43) Pub. Date: Dec. 25, 2025

(54) BATTERY ASSEMBLY

(71) Applicant: SK On Co., Ltd., Seoul (KR)

(72) Inventor: Jeong Woon KO, Seoul (KR)

(21) Appl. No.: 19/231,553

(22) Filed: Jun. 9, 2025

(30) Foreign Application Priority Data
Jun. 21, 2024 (KR) 10-2024-0081194

(51) Int. Cl. H01M 50/24; H01M 50/211; H01M 50/293

(52) U.S. Cl. CPC H01M 50/24; H01M 50/211; H01M 50/293

(57) ABSTRACT

The present disclosure relates to a battery assembly comprising: a plurality of battery cells arranged in a stacking direction; a housing case accommodating the plurality of battery cells; a sheet-shaped blocking member arranged between the plurality of battery cells along the stacking direction inside the housing case; and a first member into which at least one end of both ends of the blocking member is inserted along a protruding direction perpendicular to the stacking direction inside the housing case.

### CROSS-REFERENCE TO RELATED PATENT APPLICATION

The present application claims priority under 35 U.S.C. §119(a) to Korean patent application number 10-2024-0081194 filed on Jun. 21, 2024, in the Korean Intellectual Property Office, the entire disclosure of which is incorporated by reference herein.

### BACKGROUND OF THE INVENTION

### 1. Field

The present disclosure relates to a battery assembly. Specifically, the present invention relates to a battery assembly that improves the thermal stability of the battery assembly.

### 2. Description of the Related Art

Recently, due to a fire or explosion accident that occurred during the use of lithium secondary batteries, social concerns about the safety of battery use are increasing. Based on these social concerns, one of the major development tasks of lithium secondary batteries in recent years is to eliminate the unsafety such as fire and explosion caused by thermal runaway of battery cells.

In particular, battery modules/packs have empty spaces other than battery cells, which are energy sources. If a fire occurs due to an external impact or a problem with a battery cell, the flame may spread to an adjacent cell through an empty space, and the damage caused by the fire may increase. The risk of such fires can be the biggest obstacle to the electric vehicle market, so the design of ways to lower the spread of fires continues to be studied.

According to an aspect of the present disclosure, a problem to be solved is to improve the production efficiency of the battery assembly by reducing the difficulty of assembling the battery assembly.

According to another aspect of the present disclosure, the problem is to increase the stability of the battery assembly by increasing the heat resistance or the fire resistance.

According to another aspect of the present disclosure, the problem is to fill the empty space of the battery assembly during thermal runaway.

The present disclosure can be widely applied to electric vehicles, battery charging stations, and other green technology fields such as solar power generation and wind power generation using batteries. In addition, the present disclosure can be used in eco-friendly electric vehicles, hybrid vehicles, and the like to prevent climate change by suppressing air pollution and greenhouse gas emission.

### SUMMARY OF THE INVENTION

A battery assembly according to an embodiment of the present disclosure may comprise: a plurality of battery cells arranged in a stacking direction; a housing case accommodating the plurality of battery cells; a sheet-shaped blocking member arranged between the plurality of battery cells along the stacking direction inside the housing case; and a first member into which at least one end of both ends of the blocking member is inserted along a protruding direction perpendicular to the stacking direction inside the housing case.

The first member may comprise an inflatable flame retardant resin whose volume changes based on temperature.

The first member may comprise an inflatable flame retardant resin in which the volume of the first member increases at a second temperature higher than a first temperature.

Each of the plurality of battery cells may comprise a body accommodating an electrode assembly; and a terminal being connected to the electrode assembly and protruding outwardly from the body; and The first member may be positioned between the terminal of one of the plurality of battery cells and the terminal of another of the plurality of battery cells, with the blocking member interposed therebetween.

The blocking member may comprise a contact portion that contacts the body and a fitting portion that extends from the contact portion toward the housing case.

The first member may comprise an insertion hole formed by penetrating the first member along the protruding direction and into which at least a portion of the fitting portion is inserted.

The length of the insertion hole along the direction perpendicular to the stacking direction and the protruding direction may be smaller than the length of the first member.

The first member may further comprise an insertion groove formed by being recessed in a direction away from the plurality of battery cells along the protruding direction, into which at least a portion of the fitting portion is inserted.

The insertion groove may extend from one end of the first member to the other end along the direction perpendicular to the stacking direction and the protruding direction.

The depth of the insertion groove along the protruding direction may be greater than or equal to the length of the fitting portion inserted into the insertion groove at a first temperature.

The length of the fitting portion may be smaller than the length of the contact portion along the height direction perpendicular to the stacking direction and the protruding direction.

A battery assembly according to an embodiment of the present disclosure may further comprise an insertion space formed between the plurality of battery cells and the housing case, where the first member is positioned; and a second member arranged in the insertion space together with the first member along the stacking direction.

The blocking member and the first member may be each provided in plurality, and the second member may be positioned between the plurality of the first members or between the plurality of the first members and the housing case along the stacking direction in the insertion space.

The second member may be formed of an inflatable flame retardant resin in which the volume of the second member increases at a second temperature higher than the first temperature.

Each of the plurality of battery cells may comprise a body accommodating an electrode assembly; and a terminal being connected to the electrode assembly and protruding outwardly from the body; and the second member may be positioned between the terminal of one of the battery cells and the terminal of another battery cell adjacent to the one of the battery cells.

A battery assembly according to an embodiment of the present disclosure may comprise a plurality of battery cells arranged in a stacking direction; a housing case accommodating the plurality of battery cells; a busbar being positioned between the housing case and the plurality of battery cells and electrically connecting the plurality of battery cells; a sheet-shaped blocking member arranged between the plurality of battery cells along the stacking direction inside the housing case; and a first member into which at least one end of both ends of the blocking member is inserted along a protruding direction perpendicular to the stacking direction inside the housing case.

According to an embodiment of the present disclosure, it is possible to improve the production efficiency of the battery assembly by reducing the difficulty of assembling the battery assembly.

According to another embodiment of the present disclosure, the stability of the battery assembly may be increased by increasing heat resistance or fire resistance.

According to another embodiment of the present disclosure, the empty space of the battery assembly can be filled during thermal runaway.

### BRIEF DESCRIPTION OF THE DRAWINGS

FIG. 1 illustrates an example of a battery assembly according to the present disclosure.

FIG. 2 illustrates an example of disassembling a battery assembly according to the present disclosure.

FIG. 3 is a top view of a battery assembly according to the present disclosure.

FIG. 4 schematically illustrates an example of a battery assembly according to the present disclosure in a normal operating state.

FIG. 5 schematically illustrates an example of a battery assembly according to the present disclosure when thermal runaway occurs.

FIG. 6 schematically illustrates another example of a battery assembly according to the present disclosure in a normal operating state.

FIG. 7 illustrates an example of a first member according to the present disclosure.

FIG. 8 is a side view of an example of the first member according to the present disclosure.

FIG. 9 illustrates another example of the first member according to the present disclosure.

FIG. 10 is a side view of another example of the first member according to the present disclosure.

FIG. 11 illustrates another example of the first member according to the present disclosure.

FIG. 12 is a side view of another example of the first member according to the present disclosure.

FIG. 13 illustrates an example in which a first member and a blocking member are inserted.

FIG. 14 illustrates another example in which the first member and the blocking member are inserted.

FIG. 15 illustrates another example of a battery assembly according to the present disclosure.

### DETAILED DESCRIPTION

Hereinafter, referring to the accompanying drawings, embodiments of the present disclosure are described in detail so that those skilled in the art to which the present disclosure pertains can easily practice them. However, the present disclosure may be implemented in a number of different forms and is not limited to the embodiments described herein. Further, in order to clearly explain the present disclosure in the drawings, parts that are not related to the explanation are omitted, and similar parts are given similar reference numerals throughout the specification.

Throughout the specification, when it is mentioned that a part is “connected” to another part, it includes not only the case where they are “directly connected,” but also the case where they are “electrically connected” with another element in between.

Throughout the specification, when it is mentioned that an element is “on” another element, this includes not only the case where the element is in contact with the other element, but also the case where there is another element between the two elements.

For example, an expression indicating relative or absolute arrangement such as “in a direction,” “along a direction,” “in parallel,” “vertically,” “centrally,” “concentrically,” or “coaxially” not only strictly indicates such arrangement, but also indicates a state of relative displacement with tolerance or an angle or distance to the extent that the same function is obtained.

In order to explain the present disclosure, a spatial orthogonal coordinate system based on the X-axis, the Y-axis, and the Z-axis orthogonally to each other will be described below. Unless otherwise specified, the Z direction refers to the height direction, and the X direction (or the first direction) refers to any one of the directions perpendicular to the height direction. The Y direction (or the second direction) means a direction perpendicular to the Z direction and the X direction.

However, the X-direction, Y-direction, and Z-direction mentioned below are intended to explain the present disclosure so that it can be clearly understood, and it goes without saying that each direction may be defined differently depending on where the standard is placed.

Throughout the specification, when it is mentioned that a part “includes” or “comprises” a component, this does not mean that it excludes other components, but rather that it may include other components, unless otherwise specifically stated. The terms such as “about” and “substantially”, which indicate degrees, as used throughout the specification, are used in a meaning that is at or near a numerical value when manufacturing and material tolerances inherent in the meanings stated are given, and are used to prevent unscrupulous infringers from unfairly exploiting the disclosure, which states precise or absolute numbers to aid understanding of the present disclosure. The terms “step of doing ˜” or “step of ˜” as used throughout the specification do not mean “step for ˜”.

Hereinafter, with reference to the accompanying drawings and the description below, preferred embodiments of the present disclosure are described in detail. However, the present disclosure is not limited to the embodiments described here, but may be embodied in other forms. Throughout the specification, the same reference numerals represent the same components.

In addition, the battery assemblies 200, 300 according to the present disclosure are collectively referred to as battery modules or battery packs. Accordingly, battery assemblies 200, 300 according to the present disclosure may refer to battery modules as well as battery packs that accommodate battery cells without battery modules, such as Cell to Pack (CTP).

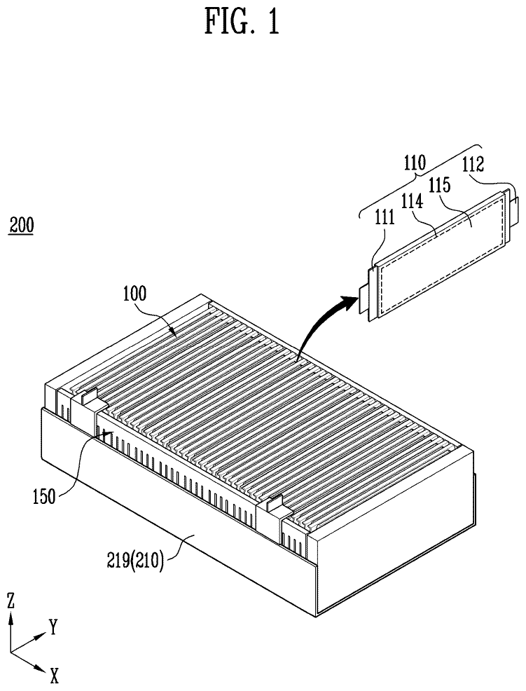

FIG. 1 is an example of a battery assembly according to the present disclosure.

Referring to FIG. 1, the battery assembly 200 may include a plurality of battery cells 110 and a housing case 210 accommodating the battery cells 110.

Each of the plurality of battery cells 110 may include a body 115 including an electrode assembly 114 therein, and terminals 111, 112 connected to the electrode assembly 114 and protruding to the outside of the body 115.

Meanwhile, the electrode assembly 114 may include a positive electrode coated with a positive electrode active material, a negative electrode coated with a negative electrode active material, and a separation membrane separating the positive electrode and the negative electrode from each other.

In addition, the plurality of battery cells 110 further include an electrolyte (not shown) in contact with the electrode assembly 114 inside the body 115. The electrolyte may be liquid or solid.

Meanwhile, FIG. 1 illustrates an example of a battery cell 110 in the form of a pouch, but is not limited thereto. Therefore, it is also applicable to rectangular and cylindrical battery cells.

Referring to FIG. 1, the terminals 111, 112 may include a first terminal 111 and a second terminal 112 protruding from both sides of the body 115 in a direction away from the body 115. For example, both terminal 111, 112 may be provided on one side.

In addition, the first terminal 111 and the second terminal 112 may have different electrical polarities.

The housing case 210 may protect the plurality of battery cells 110 from external shocks such as vibration. The housing case 210 may include a housing body 219 that forms part of a accommodating space 280 for accommodating the plurality of battery cells 110, which will be described later.

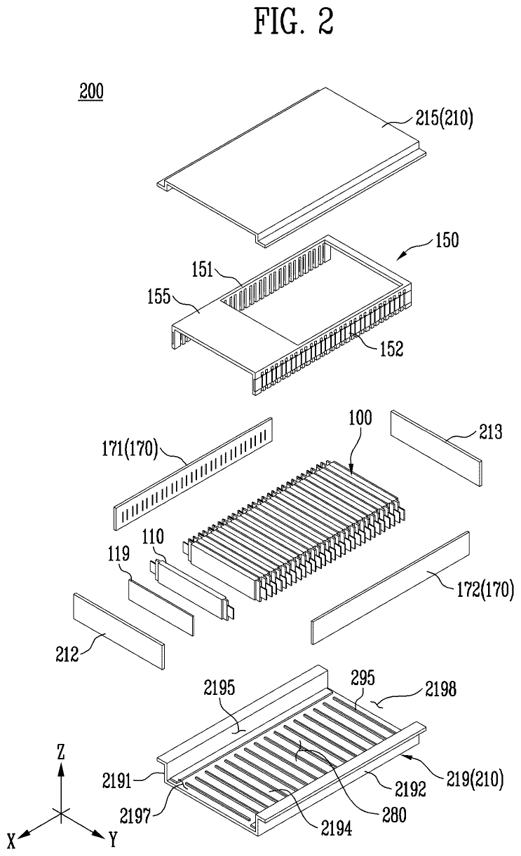

FIG. 2 is an example of disassembling a battery assembly according to the present disclosure.

Referring to FIG. 2, the housing case 210 may include a housing body 219 that forms a part of an accommodating space 280 accommodating the plurality of battery cells 110 and a cover 215 that is coupled to the housing body 219 to form the accommodating space 280 together.

The plurality of battery cells 110 may be stacked in a predetermined stacking direction (e.g., X direction) inside the housing body 219.

More specifically, the housing case 210 includes an open upper surface 2195, and may further include a housing body 219 accommodating the plurality of battery cells 110 through the open upper surface 2195, and a cover 215 that is coupled to the housing body 219 and closes the opened upper surface 2195.

Accordingly, the cover 215 may be coupled to the housing body 219 to form an upper surface of the accommodating space 280 or an upper surface of a housing case 210. That is, the cover 211 may be coupled to the housing body 219 to close the opened upper surface 2195 and form the accommodating space 280 together with the housing body 229.

The accommodation space 280 may be formed inside the housing body 219 to accommodate the cell stack 100.

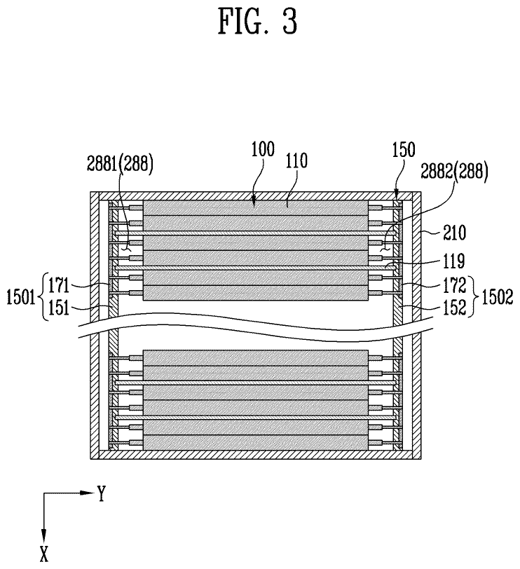

In addition, the accommodation space 280 may further include an insertion space 288 (see FIG. 3) to be described later.

Meanwhile, the housing body 219 may have a channel shape or a U-shape with an open top. Referring to FIG. 2, both side surfaces 2197, 2198 facing each other in the X direction of the side surfaces of the housing body 219 may also be opened.

That is, the housing body 219 may include a body bottom surface 2194 that forms a bottom surface of the accommodating space 280, and body side surfaces 2191, 2192 that extend toward the cover 211 at corners (not shown) of the body bottom surface 2184 that are provided side by side along the stacking direction. The free ends of the body sides 2191, 2192 may be bent to form flanges (not shown). This is for easy coupling with the cover 211.

Referring to FIGS. 1 and 2, the height of the housing body 219 may be smaller than the heights of the plurality of battery cells 110. However, this is only an example, and the height of the housing body 219 may be greater than or equal to the height of the plurality of battery cells 110.

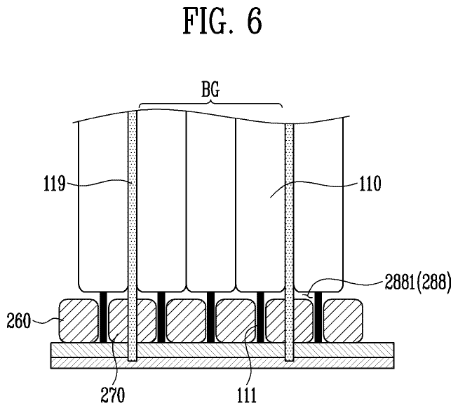

Meanwhile, the cell stack 100 may further include a blocking member 119 positioned between the plurality of battery cells 110. The blocking member 119 may be positioned between the battery cells 110, or may be positioned between battery groups BG (see FIG. 6) in which the plurality of battery cells 110 are grouped.

The blocking member 119 may serve as a thermal barrier to prevent flames or heat from spreading to other adjacent battery cells 110 when thermal runaway occurs in one battery cell 110. For this purpose, the blocking member 119 may be made of a flame-retardant material.

The blocking member 119 may be provided in a pad shape. Meanwhile, the blocking member 119 may serve as a buffer member for minimizing swelling during charging and discharging of the battery cells 110 and uniformly applying surface pressures to the plurality of battery cells 110.

To this end, the blocking member 119 may also be formed in a multilayer structure along the stacked directions of the plurality of battery cells 110. That is, at least one layer of the multilayer structure may be formed of a flame retardant material (or a fire-resistant material). In addition, the other layer of the above multi-layer structure may perform a buffering function to reduce the pressure on the other battery cell 110 when the battery cell 110 is swollen.

The cell stack 100 may include at least one blocking member 119. That is, the cell stack 100 may be positioned in at least one of the plurality of battery cells 110.

Since the blocking member 119 has a pad shape, the blocking member 119 may be in contact with adjacent battery cells 110. More specifically, the blocking member 119 may be in contact with the respective body 115 of the battery cells 110 adjacent to each other with the blocking member 119 interposed therebetween.

The plurality of battery cells 110 and the plurality of blocking members 119 may be provided at a predetermined position and stacked. For example, referring to FIG. 2, an example in which long edges of the plurality of battery cells 110 are provided side by side in the Y direction is shown. Therefore, the plurality of battery cells 110 and the plurality of blocking members 119 will be positioned to overlap in the X direction. The same applies to the blocking member 119.

The blocking member 119 may be formed of a fire-resistant (heat-resistant or flame-retardant) material. For example, the blocking member 119 may be made of a refractory polymer or a material such as mica.

Meanwhile, referring to FIG. 2, the battery assembly 200 may further include end plates 212, 213 at both ends of the cell stack 100 along the stacking direction. The end plates 212, 213 may be provided on both ends of the cell stack 100, or may be formed to be connected to both side surfaces 2197, 2198 of the housing body 219.

The end plates 212, 213 are configured to prevent both sides of the cell stack 100 from being exposed to the outside.

Meanwhile, the battery assembly 200 may include a busbar 170 electrically connected to the plurality of battery cells 110. The busbar 170 may be electrically connected to the outside to store (or charge) electrical energy in the plurality of battery cells 110, or to supply (or discharge) electrical energy stored in the plurality of the battery cells 110 to the outside.

Meanwhile, the battery assembly 200 may further include busbar frames 151, 152, 155 that support the busbar 170 and the plurality of battery cells 110. The busbar 170 and the busbar frames 151, 152, 155 may be collectively referred to as a busbar assembly 150.

Referring to FIG. 2, the busbar 170 may include a first busbar 171 and a second busbar 172 arranged along the stacking direction with the plurality of battery cells 110 interposed therebetween and electrically connected to the terminals 111, 112 of the plurality of battery cell.

The busbar frame may include a first busbar frame 151, which is extending along the stacking direction of the plurality of battery cells 110, supporting the first busbar 171 and a second busbar frame 152 supporting the second busbar 172.

The busbar frame may further include a support frame 155 positioned on one side of the busbar assembly 150 and connecting the first busbar frame 151 and the second busbar frame 152.

In the present disclosure, the busbar assembly 150 is described using a case where the terminals 111, 112 are respectively positioned in opposite directions of the body 115. However, when the terminals 111, 112 are positioned on one side of the body 115 and are arranged in the same direction, the first busbar frame 151 may be positioned on one side, e.g., on the upper portion of the body 115, and electrically connected to the terminals 111, 112.

The support frame 155 may serve to prevent and support deformation of the first busbar frame 151 and the second busbar frame 152. In addition, a part of the electrical device for sensing and controlling the plurality of battery cells 110 may be disposed on the support frame 155.

Referring to FIG. 2, the busbar assembly 150 may have a tunnel shape. The length of the first busbar frame 151 and the length of the second busbar frame 152 along the stacking direction may be longer than the length of the support frame 155.

That is, the support frame 155 may be connected to the first busbar frame 151 and the second busbar frame 152 to cover upper portions of the plurality of battery cells 110. That is, the support frame 155 may cover not only a part of the upper portions of the plurality of battery cells 110 but also all of them.

Referring to FIG. 2, the busbar 170 may include a first busbar 171 supported by the first busbar frame 151 and electrically connected to the first terminal 111, and a second busbar 172 supported by the second busbar frame 152 and electrically connected to a second terminal 112.

The first busbar 171 and the second busbar 172 may be positioned further away from the plurality of battery cells 110 than the first busbar frame 151 and the second busbar frame 152, respectively. That is, it may be positioned closer to the body side surfaces 2191, 2192 than the first busbar frame 151 and the second busbar frame 152.

Therefore, the first terminal 111 and the second terminal 112 may be inserted into slit holes (not shown) formed in the first busbar frame 151 and the second busbar frame 152, respectively, to be electrically connected to the first busbar 171 and the second busbar 172. However, this is only an example, and the first terminal 111 and the second terminal 112 may be electrically connected to the first busbar 171 and the second busbar 172 in a different manner, respectively.

Meanwhile, the battery assembly 200 may further include a heat dissipation portion 295 positioned between the body bottom surface 2194 and the plurality of battery cells 110 to transfer heat generated in the plurality of battery cell 110 to the outside of the battery assembly 200.

The heat dissipation portion 295 may be made of an adhesive material having thermal conductivity, for example, a heat dissipating adhesive. Therefore, the plurality of battery cells 110 may be bonded to the body bottom surface 2194 through the heat dissipation portion 295. To this end, the heat dissipation portion 295 may be sprayed or applied onto the body bottom surface 2194.

FIG. 3 is a top view of a battery assembly according to the present disclosure.

The busbar assembly 150 may include the first busbar assembly 1501 and the second busbar assembly 1502. In the present disclosure, the first busbar 171 and the first busbar frame 151 are collectively referred to as a first busbar assembly 1501 (see FIG. 3), and the second busbar 172 and the second busbar frame 152 are collectively referred to a second busbar assembly 1502 (see FIG. 3).

Referring to FIG. 3, an empty space (hereinafter referred to as an insertion space 288) may be formed between the plurality of battery cells 110 and the busbar assembly 150 due to the electrical connection between the terminals 111, 112 and the busbar assemblies 150. The insertion space 288 may refer to a space remaining after the cell stack 100 is accommodated as a part of the accommodation space 280.

That is, the insertion space 288 may be formed between the plurality of battery cells 110 and the housing case 210.

Alternatively, the insertion space 288 may be formed between the plurality of battery cells 110 and the busbar 170.

More specifically, the insertion space 288 may be formed between the body 115, the terminals 111, 112, and the busbar 170 of the plurality of battery cells 110.

In general, when thermal runaway occurs in any one of the plurality of battery cells 110 and gas is generated, high-temperature heat may be propagated to other adjacent battery cells 110 through the insertion space 288. In order to prevent such thermal propagation, it is necessary to fill the insertion space 288.

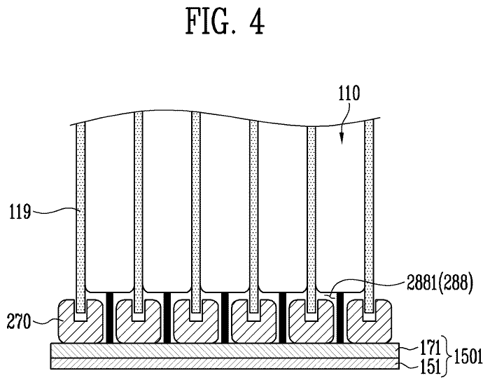

To this end, the battery assembly 200 according to the present disclosure may include a first member 270 (see FIG. 4) and a second member 260 (see FIG. 6) inserted into the insertion space 288.

That is, the battery assembly 200 according to the present disclosure may include a plurality of battery cells 110 arranged in a stacking direction, a housing case 210 accommodating the battery cells 110, an insertion space 288 formed between the battery cells 110 and the housing case 210 along the stacking direction, and a first member 270 positioned in the insertion space 288.

Meanwhile, the length of the blocking member 119 along the direction from the first busbar 171 toward the second busbar 172 or the protruding direction of the terminals 111, 112 may be longer than the length of the body 115.

More specifically, the blocking member 119 may be in contact with the first busbar assembly 1501 and/or the second busbar assembly 1502. As a result, the blocking member 119 may block or delay the propagation of heat or flame to other locations during thermal runaway of any battery cell 110.

Referring to FIG. 3, one side surface of the body 115 may be a side surface where the first terminal 111 is positioned, and the other side surface of the body 115 may be the side surface where the second terminal 112 is positioned.

For example, the insertion space 288 may include a first insertion space 2881 and a second insertion space 2882. The space of the first insertion space 2881 may be separated by the first terminal 111. In addition, the second insertion space 2882 may be separated by the second terminal 112.

However, when the cell stack 100 is accommodated in the housing body 219, the lengths of the first terminal 111 and the second terminal 112 along the height direction of the housing case 210 or the housing body 219 are smaller than the height of the battery cell 110, so that the first insertion space 2881 and the second insertion space 2882 may communicate with each other.

In addition, the first insertion space 2881 and the second insertion space 2882 may communicate with each other through a space formed between the plurality of battery cells 110 and the cover 215. Therefore, the first insertion space 2881 and the second insertion space 2882 may not be separated and isolated from each other, but may be spaces capable of communicating with each other.

FIG. 4 schematically illustrates an example of a battery assembly according to the present disclosure in a normal operating state.

FIG. 4 shows a part of the first insertion space 2881. Meanwhile, the description of the blocking member 119, the first member 270, and the second member 260 (see FIG. 6) in the first insertion space 2881 may be the same as the description of the blocking member 119, the first members 270, and the first member 260 in the second insertion space 2882. Therefore, the description of the blocking member 119, the first member 270, and the second member 260 in the second insertion space 2882 is omitted.

The battery assembly 200 according to the present disclosure may include a plurality of battery cells 110 arranged in a stacking direction, a housing case 210 accommodating the battery cells 110, and a sheet-shaped blocking member 119 arranged between the battery cells 110 in the housing case 210 along the stacking direction.

The battery assembly 200 according to the present disclosure may further include a first member 270 into which one end of at least one of both ends of the blocking member 119 is inserted along a protruding direction perpendicular to the stacking direction in the housing case 210.

Meanwhile, the battery assembly 200 according to the present disclosure may include a plurality of battery cells 110 arranged in a stacking direction, a housing case 210 accommodating the battery cells 110, a busbar 170 positioned between the housing case 210 and the battery cells 110 to electrically connect the battery cells 110 with each other, a sheet-shaped blocking member 119 arranged between the battery cells 110 in the housing case 210 along the stacking direction, and a first member 270 positioned between the busbar 170 and the battery cells 100 in the housing case 220 to insert one end of at least one of both ends of the blocking member 119 along a protruding direction perpendicular to the stacking direction.

Alternatively, the battery assembly 200 according to the present disclosure may include a first member 270 including a plurality of battery cells 110 arranged in a stacking direction, a housing case 210 accommodating the battery cells 110, a busbar 170 positioned between the housing case 210 and the battery cells 110 to electrically connect the battery cells 110 with each other, a sheet-shaped blocking member 119 arranged between the battery cells 110 in the housing case 210 along the stacking direction, and a groove or hole-shaped insertion portion (not shown) positioned between the busbar 170 and the battery cells 11 in the housing case 21 to insert one end of at least one of both ends of the blocking member 119 along a protruding direction perpendicular to the stacking direction.

The protruding direction may be a direction from the plurality of battery cells 110 toward the busbar 170. Alternatively, the protruding direction may be a direction from the first busbar 171 toward the second busbar 172. More specifically, the protruding direction may be a direction in which the terminals 111, 112 protrude from the body 115.

Referring to FIG. 4, the first member 270 may receive one end of at least one of both ends of the blocking member 119. The first member 270 may be positioned in at least one of the first insertion space 2881 and the second insertion space 2882.

Referring to FIG. 4, the first member 270 may extend along a height direction (or a direction perpendicular to the stacking direction and the protruding direction) of the housing case 210. Therefore, the first member 270 may have a columnar shape.

In addition, although the cross section of the first member 270 is shown as a square with rounded corners in the present disclosure, this is only an example, and the cross section of first member 270 may be a figure of another shape.

Referring to FIG. 4, a plurality of the blocking members 119 may be provided, and the plurality of blocking members 119 may be positioned between each of the plurality of battery cells 110.

Similarly, a plurality of the first members 270 may be also provided, and one end of each of the plurality of blocking members 119 may be inserted.

The first member 270 may be arranged in the insertion space 288 at a first temperature. The first temperature may be room temperature or a temperature at which the battery assembly 200 operates normally.

Referring to FIG. 4, the size of one cross section of the first member 270 at the first temperature may be smaller than the size of one section of the space in which the first member 270 is positioned. That is, the volume of the first member 270 at the first temperature may be smaller than the volume of the space in which the first member 270 is positioned. This is to increase the convenience of assembling.

However, when the space in which the first member 270 is positioned is empty, gas generated during thermal runaway of any one of the battery cells 110 may be discharged through the empty space. In order to minimize this, the volume of the first member 270 needs to be increased when thermal runaway occurs in at least one battery cell 110 among the plurality of battery cells 110.

Meanwhile, referring to FIG. 1 and FIG. 4, each of the plurality of battery cells 110 includes a body 115 accommodating an electrode assembly 114, and terminals 111, 112 connected to the electrode assembly 114 and protruding to the outside of the body 115, and the first member 270 may be positioned between the terminals 111, 112 of one battery cell 110 and the terminals 111, 112 of the other battery cell 110 disposed with the blocking member 119 interposed therebetween among the plurality of battery cell 110.

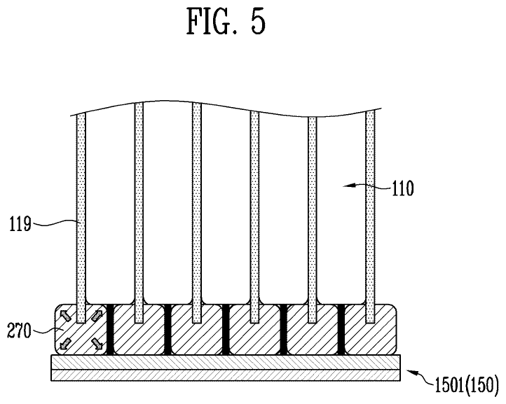

FIG. 5 schematically illustrates an example of a battery assembly according to the present disclosure when thermal runaway occurs.

When a thermal runaway occurs in any one of the battery cells 110 and a heat is transferred to another adjacent battery cell 110, the internal temperature of the battery assembly 200 or the temperature of the accommodation space 280 may be higher than the first temperature. If the volume of the first member 270 changes at a temperature higher than the first temperature (or a critical temperature), not only is an assembling of the battery assembly 200 be easy, but it can also be effective in delaying thermal propagation inside the battery assembly 200 during thermal runaway.

To this end, the first member 270 may include an inflatable flame retardant resin whose volume changes based on temperature.

More specifically, the volume of the first member 270 may include an inflatable flame retardant resin that increases at a second temperature higher than the first temperature.

For example, the second temperature (or critical temperature) may be 60° C. That is, when the second temperature is 60° C. or higher, the volume of the first member 270 gradually increases, so that the space in which the first member 270 is positioned can be filled.

On the other hand, FIG. 5 shows that one cross section of the first member 270 increases in the direction of the arrow, but this is only an example.

In addition, although FIG. 5 illustrates an example in which the volume of each of the plurality of first members 270 increases, some first members 270 positioned immediately after the occurrence of the thermal runaway or in a region where thermal propagation occurs may increase in volume first. This is because the temperature of the first member 270 may vary depending on the position.

For example, when thermal runaway occurs in any one of the battery cells 110, this is because the temperature of the first members 270 positioned on both sides of the battery cell 110 rises first.

FIG. 6 schematically illustrates another example of a battery assembly according to the present disclosure in a normal operating state.

Referring to FIG. 6, the blocking member 119 may be positioned between battery groups BG in which adjacent battery cells 110 are grouped into a number of groups.

The battery group BG refers to a set of battery cells in which adjacent battery cells 110 among the plurality of battery cells 110 are grouped into a number of groups. The plurality of battery cells 110 may be grouped into the group number for a target voltage or target current, and then the battery group BG may be connected in series or in parallel by using the busbar 170.

Referring to FIG. 6, a battery assembly 200 according to the present disclosure may include a plurality of blocking members 119. The plurality of blocking members 119 may be arranged between the battery groups BG.

Therefore, in the battery assembly 200 according to the present disclosure, an empty space may be formed between the plurality of blocking members 119 or between the plurality of second members 260. More specifically, the battery assembly 200 according to the present disclosure may further include a second member 260 arranged between the terminals 111, 112 of the grouped battery cells 110 belonging to any one of the battery groups BG along the stacking direction.

In other words, the second member 260 may be positioned between the terminal 111, 112 of any one of the plurality of battery cells 110 and the terminal 111, 112 of the other battery cell 110 adjacent to the one battery cell 110.

Alternatively, the battery assembly 200 according to the present disclosure may further include an insertion space 288 formed between the plurality of battery cells 110 and the housing case 210, where the first member 270 is positioned; and a second member 260 arranged in the insertion space 288 together with the first member 270 along the stacking direction

In addition, the blocking member 119 and the first member 270 may each be provided in a plurality, and the second member 260 may be arranged in the insertion space 288 between the plurality of the first members 270 or between the plurality of first members 270 and the housing case 210 along the stacking direction.

Meanwhile, like the first member 270, the volume of the second member 260 may include an inflatable flame retardant resin that increases at a second temperature higher than the first temperature.

The inflatable flame retardant resin may comprise at least one or a combination of flame-retardant curable monomers and oligomers and a thermally expandable particulate material.

As an example, the thermally expandable particulate material may be at least one or a combination of expandable exciters, zinc borate, stannate or molybdate, Ammonium OctaMolybdate, aluminum hydroxide (Al(OH)₃), and nanoclays.

Meanwhile, the curable monomer or oligomer may comprise nanofillers, clays and flame retardant materials.

For example, the flame retardant material may be a metal oxide, a metal hydrate, or a metal hydroxide.

More specifically, the flame-retardant material may be any one compound selected from the group consisting of aluminum (K₂SO₄·Al₂(SO₄)₃·24H₂O), borax (Na₂B₄O₇·10H₂O), an aqueous solution of lime water (Ca(OH)₂), quicklime (CaO), a white emulsion made by mixing lime porridge (Milk of Lime Ca(OH)₂) with water), slaked lime (Ca(OH)₂), washing soda (Na₂CO₃·10H₂O), apatite (Ca₅(PO₄)·3OH), baking powder (a salt mixture of NaHCO₃ and tartaric acid), baking soda (NaHCO₃), sodium thiosulfate pentahydrate (Sodium Thiosulfate Pentahydrate, Na₂S₂O₃·5H₂O), silica or silicon dioxide (SiO₂), alumina or aluminum oxide (Al₂O₃), calcium oxide (CaO), calcium sulfate (CaSO₄), calcium chloride (CaCl₂), sodium carbonate (Na₂CO₃), potassium chloride (KCl), magnesium oxide (MgO), zirconium oxide (ZrO₂), chromium oxide (Cr₂O₃), aluminum hydroxide (Al(OH)₃), antimony trioxide (Sb₂O₃), antimonyl pentoxide (Sb₂O₅), magnesium hydroxide (Mg(OH)₂) and a zinc borate compound, a phosphorus-based compound, a nitrogen-based guanidine compound, or a molybdenum compound, or a mixture thereof.

Referring to FIG. 6, the cross-sectional view of the second member 260 may have various shapes similar to those of the first member 270. For example, one cross section of the second member 260 may have a rectangular shape with rounded corners.

Meanwhile, a cross section of the first member 270 and a cross section of a second member 260 may be different from each other. In addition, the length of the first member 270 along a direction perpendicular to the stacking direction and the protruding direction may be different from the length of the second member 260.

Meanwhile, in the present disclosure, the first member 270 and the second member 260 may have the same shape, but are expressed differently to distinguish the first member 270 from the second member 260. Since it is not necessary to distinguish the first member 270 from the second member 260 during assembling, the assembling efficiency of the battery assembly 200 can be improved.

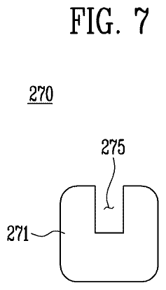

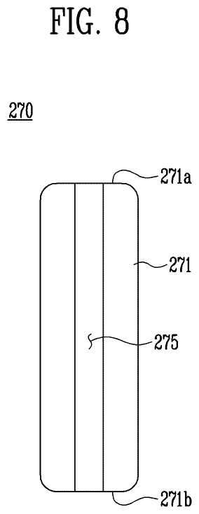

FIG. 7 illustrates an example of a first member according to the present disclosure. FIG. 8 is a side view of an example of the first member according to the present disclosure.

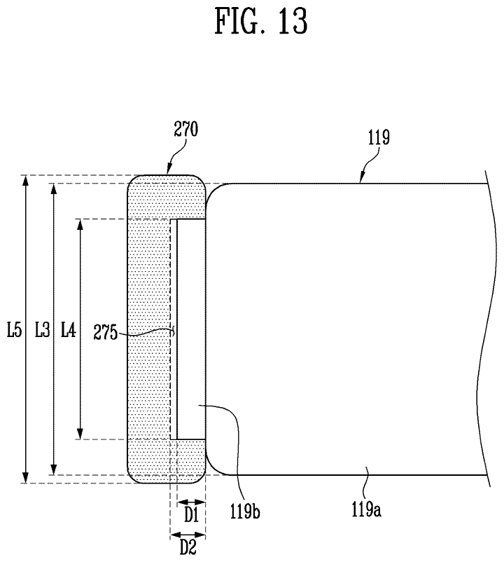

Referring to FIGS. 7 and 8, the first member 270 may further include an insertion groove 275 formed to be recessed in a direction away from the plurality of battery cells 110 along the protruding direction, into which at least a part of the fitting portion 119b (see FIG. 13) is inserted.

The first member 270 may further include a first member body 271 forming an outer shape of the first member 270, and an insertion groove 275 formed by recessing the first member body 271 along the protruding direction or a direction from the plurality of battery cells 110 toward the first busbar 171.

The first member body 271 may be formed of an inflatable flame retardant resin. The first member body 271 is formed in a columnar shape, and the columnar shape may be variously deformed. For example, the first member body 271 may have a shape tapered toward both ends.

Referring to FIG. 8, the insertion groove 275 may extend from one end 271a to the other end 271b of the first member 270 along a direction perpendicular to the stacking direction and the protruding direction. That is, the insertion groove 275 may have a channel shape or U-shape penetrating along the height direction from one end 271a to the other end 271b of the first member 270.

The insertion groove 275 is opened toward the plurality of battery cells 110, so that a part of the blocking member 119 may be inserted into the insertion groove 275.

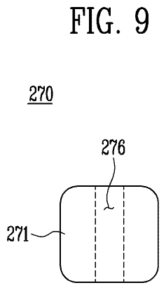

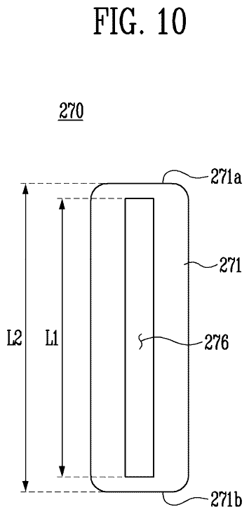

FIG. 9 illustrates another example of the first member according to the present disclosure. FIG. 10 is a side view of another example of the first member according to the present disclosure.

Referring to FIGS. 9 and 10, the first member 270 may further include an insertion hole 276 penetrating the first member 270 in a direction away from the plurality of battery cells 110 along the protruding direction.

That is, the first member 270 may include an insertion portion (not shown) into which one end of at least one of both ends of the blocking member 119 is inserted along a protruding direction perpendicular to the stacking direction in the housing case 210. The insertion portion may be a hole-shaped insertion hole 276 or a groove-shaped insertion groove 275.

Accordingly, the battery assembly 200 according to the present disclosure may include a plurality of battery cells 110 arranged in a stacking direction, a housing case 210 accommodating the plurality of battery cells 11, a sheet-shaped blocking member 119 arranged between the plurality of battery cell 110 along the stacking direction inside the housing case 210, and a first member 270 including a groove or hole-shaped insertion portion into which one end of at least one of both ends of the blocking member 119 is inserted along a protruding direction perpendicular to the stacking direction in the housing case 210.

The first member 270 may further include a first member body 271 forming an outer shape of the first member 270, and an insertion hole 276 penetrating through the first member body 271, along the protruding direction or a direction from the plurality of battery cells 110 toward the first busbar 171.

The first member body 271 may be formed of an inflatable flame retardant resin. The first member body 271 is formed in a columnar shape, and the columnar shape may be variously deformed. For example, the first member body 271 may have a shape tapered toward both ends.

Referring to FIG. 10, a length of the insertion hole 276 along the height direction may be smaller than the length of the first member 270 or the length of the first body 271. In other words, the length L1 of the insertion hole 276 along a direction perpendicular to the stacking direction and the protruding direction may be smaller than the length L2 of the first member 270. This is for the convenience of assembling, and is to prevent the assembling time from becoming longer because the first member 270 is separated into two pieces due to the insertion hole 276.

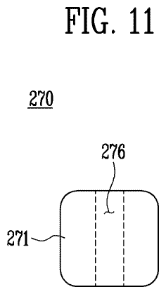

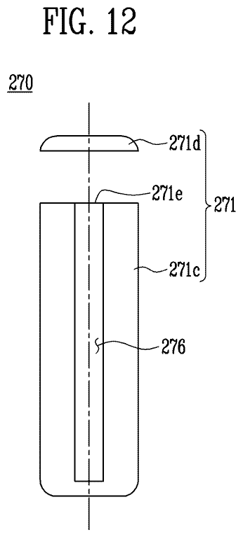

FIG. 11 illustrates another example of the first member according to the present disclosure. FIG. 12 is a side view of another example of the first member according to the present disclosure.

The first member 270 shown in FIG. 11 and FIG. 12 may have the same shape as the first member 270 illustrated in FIG. 9 and FIG. 10.

Referring to FIG. 12, the first member 270 may further include a first member body 271 forming an outer shape of the first member 270, and an insertion hole 276 penetrating through the first member body 271 along the protruding direction or the direction from the plurality of battery cells 110 toward the first busbar 171.

The first member body 271 may be separated into a first area body 271c and a second area body 271d along the height direction. This is for the convenience of assembling the blocking member 119 and the first member 270.

For example, the first area body 271c may include the insertion hole 276. The upper side 271e of the insertion hole 276 may be open. The upper side 271e of the insertion hole 276 may be formed when the second region body 271d is coupled to the first region body 271c.

Meanwhile, the first member body 271 may be formed of an inflatable flame retardant resin. The first member body 271 is formed in a columnar shape, and the columnar shape may be variously deformed. For example, the first member body 271 may have a shape tapered toward both ends.

FIG. 13 illustrates an example in which a first member and a blocking member are inserted.

When the first member 270 has a shape of an insertion groove 275, the insertion groove 275 may extend from one end to the other end of the first member 270 along the height direction. Therefore, the shape of the blocking member 119 may be a rectangular pad.

In contrast, FIG. 13 shows a case where the length L4 of the insertion groove 275 is smaller than the length L5 of the first member 270 along the height direction.

Referring to FIG. 13, the blocking member 119 may include a contact portion 119a in contact with the body 115, and a fitting portion 119b extending from the contact portion 119a toward the housing case 210 or toward the first member 270.

Meanwhile, the shape of the fitting portion 119b and the shape of the insertion hole 276 may correspond to each other. For example, the shape of the fitting portion 119b and the shape of the insertion hole 276 may be in a female-male fitting.

Referring to FIG. 13, the depth D2 of the insertion groove 275 along the protruding direction may be greater than or equal to the length D1 of the fitting portion 119b inserted into the insertion groove 295 at the first temperature. This is because the inflatability of the first member 270 was considered.

Meanwhile, a length L4 of the fitting portion 119b along a height direction perpendicular to the stacking direction and the protruding direction may be smaller than a length L3 of the contact portion 119a.

The length L3 of the contact portion 119a along the height direction may be smaller than the length L5 of the first member.

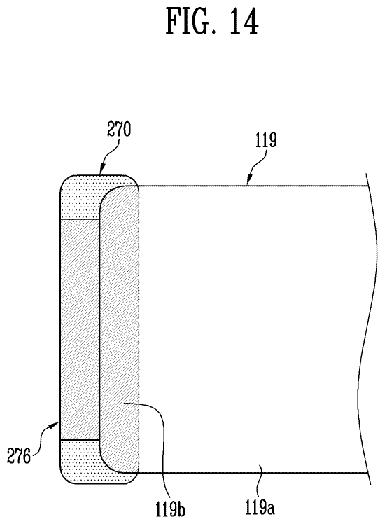

FIG. 14 illustrates another example in which the first member and the blocking member are inserted.

FIG. 14 illustrates another example in which the first member 270 includes an insertion hole 276.

For example, the blocking member 119 may include a contact portion 119a in contact with the body 115 and a fitting portion 119b extending from the contact portion 119a toward the housing case 210 or toward the first member 270.

Considering that the blocking member 119 is inserted into the first member 270, the first member 270 may include an insertion hole 276 formed through the first member 270 along the protruding direction and into which at least a part of the fitting portion 119b is inserted.

The length of the insertion hole 276 along the height direction may be constant with the length of the fitting portion 119b or the contact portion 119a. Alternatively, the shape of the insertion hole 276 may be deformed according to the shape of the fitting portion 119b and the contact portion 119a inserted into the first member 270.

Referring to FIG. 13, as the fitting portion 119b and a portion of the contact portion 119a are inserted into the insertion hole 276, the shape of the insertion hole 266 may be a shape corresponding thereto. That is, the shape of the insertion hole 276 and the shape of a portion of the fitting portion 119b and the contact portion 119a may be in a female-male fitting with each other.

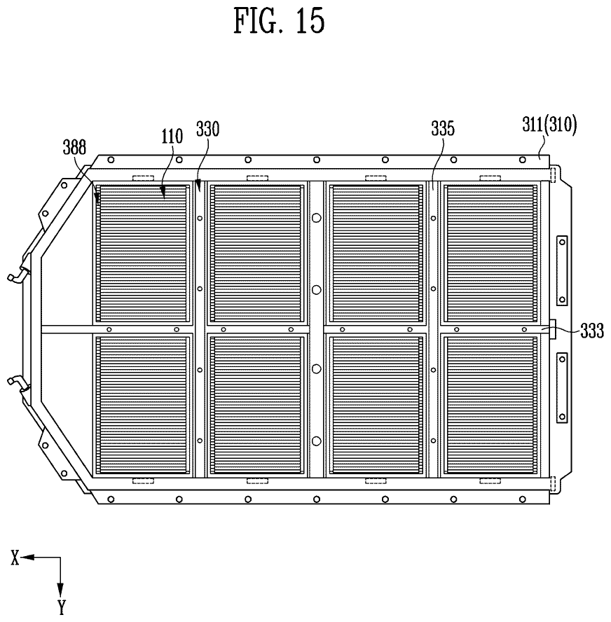

FIG. 15 illustrates another example of a battery assembly according to the present disclosure.

Although the battery assembly 200 described above is based on a battery module, FIG. 15 illustrates another example of the battery assembly 300 provided in the form of a battery pack. That is, the battery assembly 200 may be in the form of a Cell to Pack (CTP) structure in which a plurality of battery cells 110 are accommodated in the form of packs without the battery assembly.

The battery assembly 300 may include a plurality of battery cells 110 stacked and arranged in a stacking direction, a housing case 310 accommodating the plurality of battery cells, an insertion space 388 formed between the plurality of battery cell 110 and the housing case 310 along the stacking direction, and a first member (not shown) and/or a second member (not shown), arranged in the insertion space 388.

The housing case 310 may include a housing body 311 accommodating the plurality of battery cells 110 and a cover (not shown) coupled to the housing body 311. The housing case 310 may further include a partition 330 that divides the insertion space 388.

The partition 330 may further include a first frame 333 and a second frame 335 that divide the plurality of battery cells 110 horizontally and vertically. The first frame 333 and the second frame 335 are used not only to prevent deformation of the housing body 311, but also to support and separate the plurality of battery cells 110.

The above description of the present disclosure is for illustrative purposes only, and a person skilled in the art to which the present disclosure pertains will understand that the present disclosure may be easily modified into other specific forms without changing the technical idea or essential features of the present disclosure. Therefore, it should be understood that the embodiments described above are exemplary in all respects and not limiting. For example, each component described as a single entity may be implemented in a distributed manner, and likewise, components described as distributed may be implemented in a combined manner.

The scope of the present disclosure is indicated by the appended claims rather than the detailed description above, and all changes or modifications derived from the meaning and scope of the claims and their equivalent concepts should be construed as being included in the scope of the present disclosure.

What is claimed is:

1. A battery assembly comprising:
a plurality of battery cells arranged in a stacking direction;
a housing case accommodating the plurality of battery cells;
a sheet-shaped blocking member arranged between the plurality of battery cells along the stacking direction inside the housing case; and
a first member into which at least one end of both ends of the blocking member is inserted along a protruding direction perpendicular to the stacking direction inside the housing case.

2. The battery assembly according to claim 1, wherein the first member comprises an inflatable flame retardant resin whose volume changes based on temperature.

3. The battery assembly according to claim 1, wherein the first member comprises an inflatable flame retardant resin in which the volume of the first member increases at a second temperature higher than a first temperature.

4. The battery assembly according to claim 1, wherein each of the plurality of battery cells comprises a body accommodating an electrode assembly; and a terminal being connected to the electrode assembly and protruding outwardly from the body; and
wherein the first member is positioned between the terminal of one of the battery cells and the terminal of another of the battery cells, with the blocking member interposed therebetween.

5. The battery assembly according to claim 4, wherein the blocking member comprises a contact portion that contacts the body and a fitting portion extending from the contact portion toward the housing case.

6. The battery assembly according to claim 5, wherein the first member comprises an insertion hole formed by penetrating the first member along the protruding direction and into which at least a portion of the fitting portion is inserted.

7. The battery assembly according to claim 6, wherein the length of the insertion hole along the direction perpendicular to the stacking direction and the protruding direction is smaller than the length of the first member.

8. The battery assembly according to claim 5, wherein the first member further comprises an insertion groove formed by being recessed in a direction away from the plurality of battery cells along the protruding direction, into which at least a portion of the fitting portion is inserted.

9. The battery assembly according to claim 8, wherein the insertion groove extends from one end of the first member to the other end along the direction perpendicular to the stacking direction and the protruding direction.

10. The battery assembly according to claim 8, wherein the depth of the insertion groove along the protruding direction is greater than or equal to the length of the fitting portion inserted into the insertion groove at a first temperature.

11. The battery assembly according to claim 5, wherein the length of the fitting portion is smaller than the length of the contact portion along the height direction perpendicular to the stacking direction and the protruding direction.

12. The battery assembly according to claim 1, further comprising:
an insertion space formed between the plurality of battery cells and the housing case, where the first member is positioned; and
a second member arranged in the insertion space together with the first member along the stacking direction.

13. The battery assembly according to claim 12, wherein the blocking member and the first member are each provided in plurality, and wherein the second member is positioned between the plurality of the first members or between the plurality of the first members and the housing case along the stacking direction in the insertion space.

14. The battery assembly according to claim 12, wherein the second member is formed of an inflatable flame retardant resin in which the volume of the second member increases at a second temperature higher than the first temperature.

15. The battery assembly according to claim 12, wherein each of the plurality of battery cells comprises a body accommodating an electrode assembly; and a terminal being connected to the electrode assembly and protruding outwardly from the body; and
wherein the second member is positioned between the terminal of one of the battery cells and the terminal of another battery cell adjacent to the one of the battery cells.

16. A battery assembly comprising:
a plurality of battery cells arranged in a stacking direction;
a housing case accommodating the plurality of battery cells;
a busbar being positioned between the housing case and the plurality of battery cells and electrically connecting the plurality of battery cells;
a sheet-shaped blocking member arranged between the plurality of battery cells along the stacking direction inside the housing case; and
a first member into which at least one end of both ends of the blocking member is inserted along a protruding direction perpendicular to the stacking direction inside the housing case.
